(19) United States
(12) Patent Application Publication
(10) Pub. No.: US 2011/0231413 A1
(43) Pub. Date: Sep. 22, 2011

(54) TAG RELEVANCE FEEDBACK SYSTEM AND METHOD

(75) Inventors: Se Young Park, Daegu (KR); Tae Gil Noh, Daegu (KR)

(73) Assignee: Kyungpook National University Industry-Academic Cooperation Foundation, Daegu (KR)

(21) Appl. No.: 13/123,459

(22) PCT Filed: Aug. 31, 2009
(86) PCT No.: PCT/KR2009/004866

§ 371 Date: May 13, 2011

(30) Foreign Application Priority Data
Oct. 8, 2008 (KR) 10-2008-0098823

(51) Int. Cl. G06F 17/30

(52) U.S. Cl. 707/749; 707/767; 707/E17.016

(57) ABSTRACT

A system and method of feeding back tag relevance which judges the relevance of an input tag, and displays the result of the judgment using an image or a numerical value, when the input tag is input by a user. The system and method exhibit the effect of displaying, in real-time, the result of judgment of the relevance of the input tag to the user by judging the relevance of the tag with respect to specific content as soon as the tag is input so that the user can associate a relevant tag with the content. The frequency of exposure of the content with which the tag is associated is increased, since the tag is associated by obtaining the result of the judgment of the relevance in advance. A more IS appropriate search result for specific content is provided to the user by judging the relevance of the tag.

### TECHNICAL FIELD

The present invention relates to a system and method of feeding back tag relevance, and more particularly, to one which judges the relevance of an input tag, and displays the result of the judgment using an image or a numerical value, when the input tag is input by a user.

### BACKGROUND ART

In response to the pervasiveness of the Internet and digital cameras through the population, irrespective of age or gender, the amount of User-Created Content (UCC) is exponentially increasing. UCC (hereinafter, referred to as “content”) refers to an image or moving picture that is experienced, and is captured or taken, and is then uploaded by a user to a website, such as a mini homepage, a blog, or an Internet café.

As the amount of content generated in this way is explosively increasing over time, a user experiences difficulty in searching for content that he/she wishes to find.

When a user uploads content that he/she has created to an online website, the user uploads the content by associating a search word therewith, the search word being related to the content. The search word (hereinafter, referred to as a “tag”) related to the content can be regarded as being more comprehensive than a keyword.

Since the range of tags is wider than that of keywords, communication terms, abbreviations, and various emoticons, created over the Internet, are frequently used as tags. In particular, since users associate newly coined words, the origin of which cannot be identified, or user-created symbols with their content, middle-aged and elderly people, who are not accustomed to creating or finding specific content, experience even more difficulty in searching for the content.

Even if tags are created without using communication terms, abbreviations, or emoticons, different tags can be associated with pieces of content that have the same substance, according to the varying preferences of users.

In an example, user A can associate the tag “mobile phone” with specific content that was produced by photographing a mobile phone, whereas user B can associate the model nickname “Secret phone” as a tag with the same content, user C can associate the model name “LG-KU6000” as a tag with the same content, and user D can associate the model name of the camera that was used to take the picture of the mobile phone with the content. In this way, various types of tags can be associated with the same content.

In addition, whether or not the tag is helpful in the search for finding the content is determined depending on the type of the tag that is used.

In an example, user A can associate four tags, including “Paris, France,” “Eiffel Tower,” “Autumn day,” and “Nearby street picture,” with a picture of the Eiffel Tower in Paris, France, whereas user B can associate one tag “Picture of Paris,” and user C can associate one tag “Eiffel Tower” with the same picture.

If the search is performed on the Internet based on the tag “Picture of Paris” of user B, thousands to tens of thousands of results, including unnecessary noises such as pictures of objects that are given the name Paris, are found.

In addition, if the search is performed on the Internet using the tag “Eiffel Tower” of user C, hundreds to thousands of results are found, which is less than the number found using the tag “Picture of Paris” of user B. Thus, it can be determined that the tag “Eiffel Tower” of user C is more relevant than the tag “Picture of Paris” of user B.

However, since hundreds to thousands of results are also found using the tag “Eiffel Tower,” users have problems in that they must waste a lot of time in order to find intended content.

In addition, when a user associates a tag with specific content, it is difficult to judge whether or not the tag is relevant to the content. This is the same when a user searches for specific content using a tag.

### DISCLOSURE

### Technical Problem

The present invention has been devised in order to solve the foregoing inconvenience and problems, and therefore an object of the present invention is to provide a method that guides a user to input a tag that is relevant to specific content.

### Technical Solution

In order to realize the foregoing object, in an aspect of the present invention, the system of feeding back tag relevance over a network that connects a user and a server to each other includes: a browser receiving an input tag related to predetermined content, the input tag being input by a user, and displaying a relevance of the input tag using an image or a numerical value; and a server judging, in real-time, the relevance of the input tag by receiving the input tag sent from the browser, and sending the relevance of the input tag to the browser.

In a more preferable aspect of the invention, the browser includes: a first feedback User Interface (UI) displaying the relevance of the input tag based on the result of the judgment of the relevance of the input tag; and a second feedback UI displaying relevant content that is related to the input tag based on the result of the judgment of the relevance of the input tag.

In a more preferable aspect of the invention, the first UI changes the size and the color gradation of the input tag based on the result of the judgment of the relevance of the input tag.

In particular, in an aspect of the invention, the first feedback UI further changes the color of an input window to which the input tag is input based on the result of the judgment of the relevance of the input tag, or displays an indication using indicators having red, yellow, and green colors or a numerical value based on the result of the judgment of the relevance of the input tag.

In a more preferable aspect of the invention, the server includes: a first feedback module calculating the relevance of the input tag sent from the browser; a second feedback module searching for the relevant content that is related to the input tag; and a memory storing a query preference value that is used by the first feedback module and the relevant content that is related to the input tag, the input tag being used by the second feedback module.

In a more preferable aspect of the invention, the first feedback module includes: a first calculator producing a first calculation value by searching for and calculating the query preference value of the input tag; and a second calculator producing a second calculation value by acquiring and calculating, if a plurality of the input tags is input, a numerical value of a search result based on combinations of the input tags.

In a more preferable aspect of the invention, the first feedback module further includes a third calculator producing a third calculation value by adding weights to the first and second calculation values and calculating the first and second calculation values to which the weights are added.

In particular, in an aspect of the invention, the memory includes: a query DB storing query preference values for tags, the query preference values being used as queries over a network by the user, and the tags corresponding to the query preference values by sorting the query preference values in descending order; a tag DB storing, if a plurality of the input tags is input by the user, combinations of the input tags; and a search DB storing, when search for the input tags is performed, the relevant content that is acquired.

In order to realize the foregoing object, in an aspect of the present invention, the method of feeding back tag relevance includes: a first step of receiving an input tag related to predetermined content, the input tag being input by a user; a second step of judging, in real-time, a relevance of the input tag; and a third step of displaying a result of judging the relevance of the input tag using an image or a numerical value.

In a more preferable aspect of the invention, the second step includes at least one of: a process (2-1) of performing quantitative calculation on the input tag; and a process (2-2) of searching for the relevant content that is related to the input tag by performing qualitative calculation on the input tag.

In a more preferable aspect of the invention, the step (2-1) includes at least one of: a first calculation process of producing a first calculation value by searching for and calculating a query preference value corresponding to the input tag; and a second calculation process of producing, if a plurality of pairs of tags is input by the user, a second calculation value by acquiring and calculating a numerical value of a search result based on a combination of the input tags

In a more preferable aspect of the invention, the process (2-1) further includes a third process of producing a third calculation value by adding weights to the first and second calculation values and calculating the first and second calculation values to which the weights are added.

In a more preferable aspect of the invention, the third step includes at least one of: a process (3-1) of displaying the result of judging relevance of the input tag using the input tag; and a process (3-2) of displaying relevant content based on the result of judging the relevance of the input tag without using the input tag.

In particular, in an aspect of the invention, the process (3-1) includes changing the size and the color gradation of the input tag based on the result of judging the relevance of the input tag.

In particular, in an aspect of the invention, the process (3-2) includes changing the color of an input window to which the input tag is input based on the result of judging the relevance of the input tag; or displaying an indication using indicators having red, yellow, and green colors or a numerical value based on the result of judging the relevance of the input tag.

### Advantageous Effects

According to embodiments of the invention, the system and method of feeding back tag relevance exhibit the effect of displaying, in real-time, the result of judgment of the relevance of an input tag to a user by judging the relevance of the tag with respect to specific content as soon as the tag is input so that the user can associate a relevant tag with the content.

In addition, there is an effect in that it is possible to increase the frequency of exposure of the content with which the tag is associated, since the tag is associated by obtaining the result of the judgment of the relevance in advance.

Furthermore, there is an effect in that it is possible to provide a more appropriate search result for specific content to the user by judging the relevance of the tag with respect to the content.

### DESCRIPTION OF DRAWINGS

FIG. 1 is a block diagram showing a system of feeding back tag relevance according to an exemplary embodiment of the invention;

FIG. 2 is a block diagram showing the server in the system of feeding back tag relevance according to an exemplary embodiment of the invention;

FIG. 3 is a flow diagram showing a method of feeding back tag relevance according to an exemplary embodiment of the invention;

FIG. 4 is a flowchart showing the step of calculating tag relevance in the method of feeding back tag relevance according to an exemplary embodiment of the invention; and

FIG. 5 is a flowchart showing the step of displaying the result of calculation in the method of feeding back tag relevance according to an exemplary embodiment of the invention.

<Major Reference Numerals of the Drawings>

| | |
|---|---|
| 100: browser | 200: network |
| 300: server | |

### BEST MODE

A system and method of feeding back tag relevance of the invention can be embodied in various forms, and exemplary embodiments thereof will be described hereinafter with reference to the accompanying drawings.

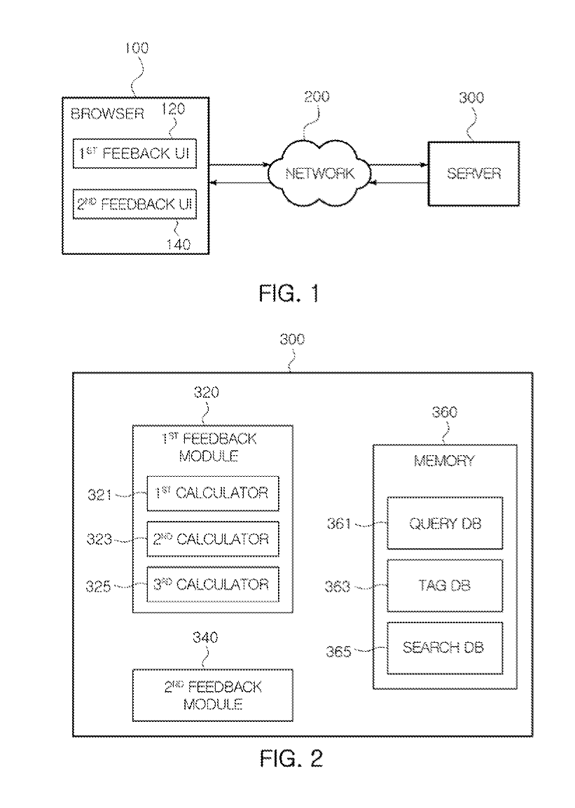

FIG. 1 is a block diagram showing a system of feeding back tag relevance according to an exemplary embodiment of the invention.

As shown in FIG. 1, the system of feeding back tag relevance of this embodiment includes a browser 100, which receives and displays a tag that is input thereto, a network 200, and a server 300, which judges the relevance of the input tag.

The browser 100 includes a first feedback User Interface (UI) 120 and a second feedback UI 140, which display the result of the judgment of the relevance of the tag.

The first feedback UI 120 receives the result of the judgment of the relevance of the input tag that is sent from the server 300, and based on the result of the judgment, displays the input tag by changing its size and color gradation.

In addition, the first feedback UI 120 changes the color of the input window to which the tag is input based on the result of the judgment, or displays the tag using indicators having red, yellow, and green colors or using a numerical value based on the result of the judgment.

The second feedback UI 140 receives the result of the judgment of the relevance of the input tag that is sent from the server 300, and displays specific content related to the input tag to a user.

The network 200 includes search engines based on the Internet and various wired/wireless communication networks, and preferably uses the Asynchronous JavaScript and XML (AJAX) protocol in order to update the result of the judgment of the relevance of the input tag in real-time.

The server 300 includes a first feedback module 320, a second feedback module 340, and a memory 360.

The first feedback module 320 includes first to third calculators 321, 323, and 325, which calculate the relevance of the tag that is sent from the browser 100.

The first calculator 321 produces a first calculation value by acquiring a query preference value of the input tag from the memory, and calculating the query preference value of the input tag.

If a plurality of tags is input, the second calculator 323 produces a second calculation value by acquiring the numerical value of search results based on combinations of the input tags from the memory 360, and calculating the numerical value of search results.

The third calculator 325 produces a third calculation value by adding weights to the first and second calculation values that are output from the first and second calculators 321 and 323, and then performing mutual calculation on the first and second calculation values.

The second feedback module 340 receives the result of judgment of the relevance of the tag that is sent from the server 300, and displays specific content related to the input tag to the user.

The memory 360 includes a query Database (DB) 361, a tag DB 363, and a search DB 365, which store information used between the first and second feedback modules 320 and 340.

The query DB 361 stores query preference values for tags that are used as queries, as well as tags corresponding to the query preference values by sorting the query preference values in descending order.

If a plurality of tags is input, the tag DB 363 stores combinations of the input tags.

The search DB 365 stores relevance content that is related to the input tags.

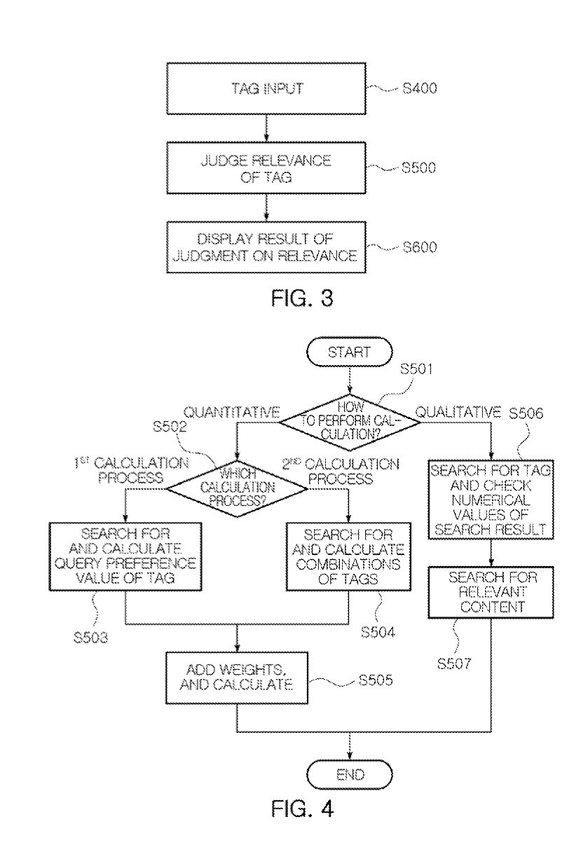

A description will be given below of a method of feeding back tag relevance according to an exemplary embodiment of the invention with reference to FIG. 3.

As shown in FIG. 3, the method of feeding back tag relevance includes step S400 of receiving a tag related to specific content that is input by a user, step S500 of judging whether or not the tag is relevant to the content, and step S600 of displaying the result of the judgment to a user.

In the method of feeding back tag relevance of this embodiment, step S500 of judging whether or not the tag is relevant to the content will be described in greater detail with reference to FIG. 4.

As shown in FIG. 4, at step S501, how to perform calculation on an input tag is determined. If it is determined to perform the quantitative calculation on the input tag, at step S502, one of first and second calculation processes is selected.

As one process of the quantitative calculation, the first calculation process is a calculation process that considers whether or not a tag that is frequently used by a number of users is associated with corresponding content as a basis when judging the relevance of the tag.

If the first calculation process is selected, at step S503, a first calculation value is produced by acquiring query preference values of the input tag from the query DB 361, and calculating the acquired query preference values with the average value of the tag.

In an example, if the input tags are “Paris,” “Eiffel Tower,” and “winter,” a first calculation value 0.4 can be produced by acquiring the query preference values 0.6, 0.5, and 0.1 for the tags “Paris,” “Eiffel Tower,” and “winter” from the query DB 361, and calculating the average ((0.6+0.5+0.1)÷3) of the query preference values.

In other words, the first calculation process judges the relevance of the tag based on the frequency of use of the tag.

In contrast, as the other process of the quantitative calculation, the second calculation process is a calculation process that considers whether or not a tag that is less frequently used is associated with corresponding content as a basis when judging the relevance of the tag.

If the second calculation process is selected at step S502 above, at step S504, a plurality of pairs of tags is input, and a second calculation value is produced by acquiring combinations of the tags from the tag DB 363, and calculating the numerical value of search results of the individual combinations.

In an example, when three tags “Paris,” “Eiffel Tower,” and “winter” are input, 2000 of the numerical value of search results are acquired first by searching the tag DB 363, which contains a total of 100 thousands of documents, using combinations of “Paris,” “Eiffel Tower,” and “winter,” and are then subjected to calculation (log(100,000/2,000)).

Otherwise, 100 of the numerical value of search results are acquired by searching the tag DB 363 using combinations of “Paris” and “Eiffel Tower,” and are then subjected to calculation (log(100,000/100)).

Otherwise, 1000 of the numerical value of search results are acquired by searching the tag DB 363 using combinations of “Paris” and “winter,” and are then subjected to calculation (log(100,000/1,000)).

By calculating the average ((1.69+3+2)/3) of the calculation values that are acquired through the foregoing calculation processes, a second calculation value 2.23 is produced.

Unlike the first calculation process, the second calculation process is based on the scarcity of the combination of the tags that are input by the user. Association of the tags through the second calculation process leads to an advantage in that the user can more rapidly find desired content.

In another example, a description will be given of a third calculation process, which reflects both the first and second calculation processes.

At step S505, the third calculation process produces a third calculation value by adding weights to the first and second calculation values that are produced in the foregoing processes, and then performing mutual calculation on the first and second calculation values.

In an example, a weight of 1 is added to a first calculation value of 0.4 that is produced through the first calculation process, a weight of 1 is added to a second calculation value of 2.23 that is produced through the second calculation process, and the two weighted values are multiplied with each other, thereby producing a third calculation value of 0.892.

Accordingly, the third calculation process can be regarded as satisfying both the bases since, it includes the first calculation process as the basis for judging how often the associated tag is used and the second calculation process as the basis for judging how scarcely the associated tag is used.

In addition, at step S501 of determining how to perform calculation on an input tag, if it is determined to perform the qualitative calculation on the input tag without performing the quantitative calculation on the input tag, at step S506, the numerical value of search results is acquired by searching for the input tag in the search DB 365.

In an example, when “winter,” “people,” “Eiffel Tower,” and “lining up” are input as tags, no search results can be acquired when search is performed using “winter, people, Paris, Eiffel Tower.” Thus, the numerical value of search results is checked, and search is performed again using “winter, people, lining up.” Afterwards, depending on the numerical value of search results, search is performed again using “winter people, Eiffel Tower” and “people, Eiffel Tower, lining up.”

Accordingly, at step S507, a tag that is selected based on the numerical value of search results is acquired from the search DB through the search, and thus content with which the tag is associated is identified. Here, the content can be referred to as relevant content that is related to the corresponding tag.

In an example, when the user intends to find a landscape picture that is taken at a long distance using tags “Paris,” “Eiffel Tower,” and “winter landscape,” not only landscape pictures that the user intends to search, but also a variety of other pictures, including pictures of people lined up in order to enter the Eiffel Tower, night view pictures of the Eiffel Tower, pictures of a group of people taken in front of the Eiffel Tower, and the like, is searched. Here, the pictures acquired together with the landscape pictures, such as the pictures of people lined up in order to enter the Eiffel Tower, the night view pictures of the Eiffel Tower, and the pictures of a group of people taken in front of the Eiffel Tower, become relevant content.

Accordingly, various judgment results for judging whether or not the input tag is relevant are obtained.

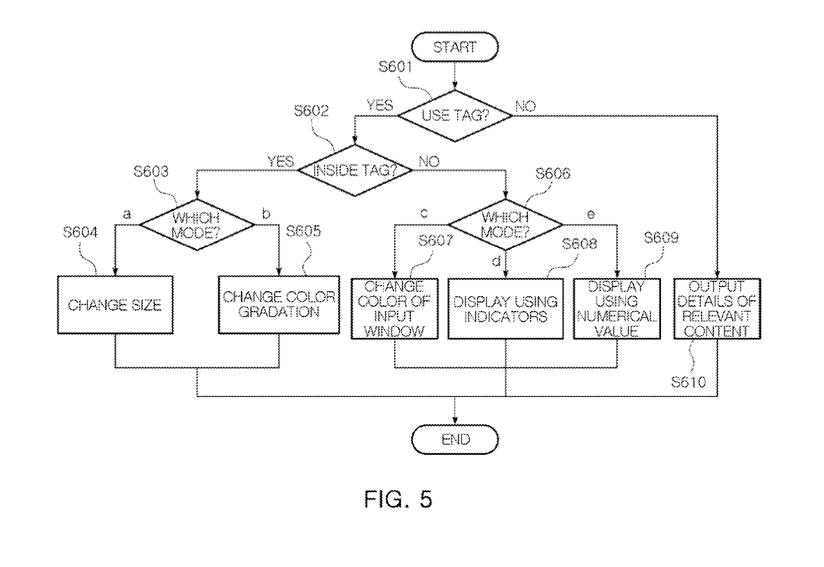

A detailed description will be given below of the step of displaying the result of calculation in the method of feeding back tag relevance according to an exemplary embodiment of the invention with reference to FIG. 5.

As shown in FIG. 5, in step S601, it is judged whether or not to display the result of the judgment of the relevance using the input tag.

In the case of displaying the result of the judgment of the relevance using the input tag, at step S602, it is judged again whether or not to display the result of the judgment inside the input tag.

In the case of displaying the result of the judgment inside the input tag, at step S603, a display mode is selected.

At step S604, mode “a” involves judging, when a period (.), a comma (,), a space key, or an enter key is input after the tag is input by the user, the relevance of the input tag, and changing the size of the input tag based on the result of the judgment before the next tag is input by the user.

In an example, the size of the input tag is increased if it is judged that the relevance of the input tag is high, and the size of the input tag is decreased if it is judged that the relevance of the input tag is low, so that the user who inputs the tag can recognize the relevance of the tag with eyes. In this fashion, this step guides the user to input a more appropriate tag.

At step S605, mode “b” involves judging, after the tag is input by the user, the relevance of the input tag, and changing the color gradation of the input tag based on the result of the judgment.

In other words, the color gradation can be changed based on the result of judgment of the relevance of a plurality of tags that is input so that changes in the colors of respective tags can be recognized with eyes.

In contrast, in the case of not displaying the result of the judgment inside the input tag, at step S606, a display mode is selected.

At step S607, mode “c” involves changing the color of the entire input window to which the tag is input by the user.

In an example, if the relevance of the input tag is judged to be high, the color of the entire input window can be changed to a bright color or to a specific color that is selected by the user.

At step 608, mode “d” involves changing the color of the input tag to green if the result of the judgment is “high,” to yellow if the result of the judgment is “middle,” and to red if the result of the judgment is “low” as in a traffic light by dividing the result of the judgment of the relevance into three levels including “high,” “middle,” and “low.”

Fool At step S609, mode “e” involves displaying the result of the judgment of the input tag, namely a calculation value, expressed using a numerical value, at a position next to the input window to which the tag is input.

Otherwise, in the case of not displaying the result of the judgment of the relevance using the input tag, at step S610, details of searched relevant content that is related to the tag are output at a position next to the tag input window so that the user can see the relevant content as soon as he/she inputs the tag.

As above, when the user inputs the tag into the input window, the relevance of the input tag is judged, and the result of the judgment of the relevance of the input tag is notified to the user.

As described above, the invention, the system and method of feeding back tag relevance of the present invention exhibit the effect of displaying, in real-time, the result of judgment of the relevance of an input tag to a user by judging the relevance of the tag with respect to specific content as soon as the tag is input so that the user can associate a relevant tag with the content.

In addition, there is an advantage in that it is possible to increase the frequency of exposure of the content with which the tag is associated, since the tag is associated by obtaining the result of the judgment of the relevance in advance.

Furthermore, there is an advantage in that it is possible to provide a more appropriate search result for specific content to the user, who searches for the content, by judging the relevance of the tag with respect to the content.

The system and method of feeding back tag relevance of the present invention have been described above. It is to be understood that by a person having ordinary skill in the art can make a variety of specific forms from the technical features of the invention without changing the principle or essential characteristics of the invention.

Therefore, it should be understood that the foregoing embodiments should be regarded as illustrative rather than limiting. The scope of the present invention is not defined by the detailed description as set forth above but by the accompanying claims of the invention, and all alterations or modifications derived from the definitions and scopes of the claims and their equivalents fall within the scope of the invention.

### INDUSTRIAL APPLICABILITY

According to the present invention, the system and method of feeding back tag relevance exhibit the effect of displaying, in real-time, the result of judgment of the relevance of an input tag to a user by judging the relevance of the tag with respect to specific content as soon as the tag is input so that the user can associate a relevant tag with the content. It is possible to increase the frequency of exposure of the content with which the tag is associated and provide a more appropriate search result for specific content to the user. In particular, in the case of web search, correct content search results can be provided to users who use websites. Therefore, the present invention has great industrial applicability.

1. A system of feeding back tag relevance over a network that connects a user and a server to each other, comprising:
a browser receiving an input tag related to predetermined content, the input tag being input by a user, and displaying a relevance of the input tag using an image or a numerical value; and
a server judging, in real-time, the relevance of the input tag by receiving the input tag sent from the browser, and sending the relevance of the input tag to the browser.

2. The system of claim 1, wherein the browser comprises:
a first feedback user interface displaying the relevance of the input tag based on a result of the judgment of the relevance of the input tag; and
a second feedback user interface displaying relevant content that is related to the input tag based on the result of the judgment of the relevance of the input tag.

3. The system of claim 2, wherein the first feedback user interface changes a size and a color gradation of the input tag based on the result of the judgment of the relevance of the input tag.

4. The system of claim 2, wherein the first feedback user interface further changes a color of an input window to which the input tag is input based on the result of the judgment of the relevance of the input tag, or displays an indication using indicators having red, yellow, and green colors or a numerical value based on the result of the judgment of the relevance of the input tag.

5. The system of claim 1, wherein the server comprises:
a first feedback module calculating the relevance of the input tag sent from the browser;
a second feedback module searching for the relevant content that is related to the input tag; and
a memory storing a query preference value that is used by the first feedback module, and the relevant content that is related to the input tag, the input tag being used by the second feedback module.

6. The system of claim 5, wherein the first feedback module includes:
a first calculator producing a first calculation value by searching for and calculating the query preference value of the input tag; and
a second calculator producing a second calculation value by acquiring and calculating, if a plurality of the input tags is input, a numerical value of a search result based on combinations of the input tags.

7. The system of claim 6, wherein the first feedback module further includes:
a third calculator producing a third calculation value by adding weights to the first and second calculation values and calculating the first and second calculation values to which the weights are added.

8. The system of claim 5, wherein the memory includes:
a query database storing query preference values for tags, the query preference values being used as queries over a network by the user, and the tags corresponding to the query preference values by sorting the query preference values in descending order;
a tag database storing, if a plurality of the input tags is input by the user, combinations of the input tags; and
a search database storing, when search for the input tags is performed, the relevant content that is acquired.

9. A method of feeding back tag relevance, comprising:
a first step of receiving an input tag related to predetermined content, the input tag being input by a user;
a second step of judging, in real-time, a relevance of the input tag; and
a third step of displaying a result of judging the relevance of the input tag using an image or a numerical value.

10. The method of claim 9, wherein the second step comprises at least one of:
a process (2-1) of performing quantitative calculation on the input tag; and
a process (2-2) of searching for the relevant content that is related to the input tag by performing qualitative calculation on the input tag.

11. The method of claim 10, wherein the step (2-1) comprises at least one of:
a first calculation process of producing a first calculation value by searching for and calculating a query preference value corresponding to the input tag; and
a second calculation process of producing, if a plurality of pairs of tags is input by the user, a second calculation value by acquiring and calculating a numerical value of a search result based on a combination of the input tags.

12. The method of claim 11, wherein the process (2-1) further comprises:
a third process of producing a third calculation value by adding weights to the first and second calculation values and calculating the first and second calculation values to which the weights are added.

13. The method of claim 9, wherein the third step comprises at least one of:
a process (3-1) of displaying the result of judging relevance of the input tag using the input tag; and
a process (3-2) of displaying relevant content based on the result of judging the relevance of the input tag without using the input tag.

14. The method of claim 13, wherein the process (3-1) comprises changing a size and a color gradation of the input tag based on the result of judging the relevance of the input tag.

15. The method of claim 13, wherein the process (3-2) comprises:
changing a color of an input window to which the input tag is input based on the result of judging the relevance of the input tag; or
displaying an indication using indicators having red, yellow, and green colors or a numerical value based on the result of judging the relevance of the input tag.
